(19) United States
(12) Patent Application Publication
(10) Pub. No.: US 2025/0051538 A1
(43) Pub. Date: Feb. 13, 2025

(54) PROCESS FOR PRODUCING A MIXED FILLER

(71) Applicant: SEMPLASTICS, LLC, Oviedo, FL (US)

(72) Inventors: Brian MUELLER, Oviedo, FL (US); Walter SHERWOOD, Oviedo, FL (US); William Easter, Oviedo, FL (US)

(21) Appl. No.: 18/720,063

(22) PCT Filed: Dec. 14, 2022
(86) PCT No.: PCT/US2022/052842

§ 371 Date: Jun. 14, 2024

Related U.S. Application Data
(60) Provisional application No. 63/289,433, filed on Dec. 14, 2021.

(51) Int. Cl. C08K 3/26; B01D 53/62; B01D 53/78; C08K 3/08; C08K 5/14; C08K 11/00; C08L 83/04; E21B 41/00

(52) U.S. Cl. CPC C08K 3/26; B01D 53/62; B01D 53/78; C08K 3/08; C08K 5/14; C08K 11/005; C08L 83/04; E21B 41/0064; B01D 2251/404; B01D 2251/604; B01D 2257/504; B01D 2258/01; C08K 2003/0818; C08K 2003/262

(57) ABSTRACT

Various embodiments provide an integrated carbon capture, utilization and storage (CCUS) process that can convert CO₂ to Group 2 carbonates and subsequent encapsulation and sequestration process to convert the carbonates to commercially useful aggregate, useful in plastics, building materials, mineral boards, concrete and road materials and make a feedstock of water useful for carbon neutral or carbon negative chloralkali and green hydrogen manufacture.

### BACKGROUND

Climate change represents one of the most important issues of our time mainly due to the large emission of carbon dioxide (CO₂). Several methods of carbon capture, utilization, and storage (CCUS) of CO₂ are being investigated, including physical sequestration methods such as storage in geological formations, oceans, or below the seabed. Mineral carbonation is a potential storage method for CO₂ that involves the formation of stable carbonates by the reaction of CO₂ with naturally occurring oxides or silicates of magnesium, iron, and calcium. Attempts have been made to speed up the chemical reactions, which occur naturally on a geological timeframe, to industrially useable timeframes.

Evidence exists to support the viability of an in-situ approach to mineral carbonation, which would involve injection of CO₂ into a mineral formation. However, the potential of in-situ mineral carbonation is hampered by slow reaction rate, large material and energy requirements, and by limited access to the minerals underground in sufficient surface area to capture a significant amount of CO₂. An ex-situ approach to mineral carbonation has also been studied. It is known that CO₂ can chemically react with alkaline earth metal chlorides, hydroxides, silicates, and oxides in solution.

One potential source of minerals for mineral carbonation is “produced water.” Oil- and gas-bearing rocks may contain water, which may be extracted along with the oil or gas. Hydraulic fracturing may also introduce additional water to an oil or gas bearing formation. As used herein, all water produced from an oil and/or gas extraction is referred to as “produced water.” In other words, as used herein “produced water” includes any aqueous liquid phase that is co-produced from a producing well along with the oil and/or gas phases during normal production operations. This includes water naturally occurring alongside hydrocarbon deposits, as well as water injected into the ground. As used herein, the term produced water also encompasses solution mine water, and geothermal water.

Produced water is a hazardous waste that can be expensive to dispose of. In addition to having a high level of total dissolved solids, produced water may include any or all of the following contaminants: oil and grease; suspended solids; dispersed oil; dissolved and volatile organic compounds; heavy metals; radionuclides; dissolved gases and bacteria; and various chemicals additives used in production, such as biocides, scale inhibitors, corrosion inhibitors, emulsion breakers, and reverse-emulsion breakers. The amount of produced water, and the contaminants and their concentrations present in produced water usually vary significantly over the lifetime of a field. Early on, the water generation rate can be a very small fraction of the oil production rate, but it can increase with time to tens of times the rate of oil produced. In terms of composition, the changes are complex and site-specific because they are a function of the geological formation, the oil, rock/fluid interactions, the type of production, required additives for oil-production-related activities, as well as the water chemistry, including both the in-situ, pre-existing water chemistry and the water chemistry of any injected water.

Recycling produced water is a priority within the oil and gas industry. One of the challenges is the “hardness” of the water. Hardness refers to the concentration of Ca, Sr, Ba and Mg. These minerals can render the water difficult to use in fracturing operations due to their incompatibility with frac chemistry. In addition, these minerals react to form solid scale in places that can cause problems, such as in pipelines, in pits, or in wells. It would be desirable to remove the Group 2 minerals through mineral carbonation. However, this is generally cost prohibitive due to the massive volume or mass of solids which must be disposed of. For example, a 100,000 bbl/day facility would produce >1,125 tons of solid waste per day.

Prior art attempts to recycle produced water have failed because the produced water is difficult and expensive to purify. With respect to oil and gas produced water, the treatment cost strongly depends on the physical and chemical characteristics of the produced water, which may vary widely among production fields and may also change over time within a given field. Variations in the regulatory environment also add to the difficulty of developing a reliable treatment process.

The discussion of shortcomings and needs existing in the field prior to the present invention is in no way an admission that such shortcomings and needs were recognized by those skilled in the art prior to the present disclosure.

### BRIEF DESCRIPTION OF THE FIGURES

Many aspects of this disclosure can be better understood with reference to the following figures.

FIG. 1 is an example according to various embodiments, illustrating a schematic flow diagram of a process for extracting various products from produced water, including a solids product, which may be further processed to produce a mixed filler.

FIG. 2 is an example according to various embodiments, illustrating a schematic flow diagram of a desalination process which may be employed in a process for producing a mixed filler from produced water.

FIG. 3 is an example according to various embodiments, illustrating a schematic flow diagram of a process for producing and using a mixed filler from produced water.

FIG. 4 is an example according to various embodiments, illustrating a first portion of an encapsulation and sequestration process for producing a mixed filler from a solids product obtained from produced water and for using the mixed filler.

FIG. 5 is an example according to various embodiments, illustrating a second continuing portion of the encapsulation and sequestration process illustrated in FIG. 4, detailing the use of the mixed filler in a masterbatch process.

FIG. 6 is an example according to various embodiments, illustrating a schematic diagram of an equipment configuration used in an experimental test of a liquid/solids separation of produced water.

FIG. 7A is an example according to various embodiments, illustrating a photograph of an experimental setup for the example presented herein.

FIG. 7B is an example according to various embodiments, illustrating a photograph of an air diffuser used in the example presented herein.

FIG. 7A is an example according to various embodiments, illustrating a photograph of a specification sheet for an air/gas pump used in the example presented herein.

The various embodiments are not limited to the examples illustrated in the figures.

### DETAILED DESCRIPTION

### Introduction and Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

In this specification and in the claims that follow, reference will be made to a number of terms that shall be defined to have the following meanings unless a contrary intention is apparent.

As used herein, the term “standard temperature and pressure” generally refers to 25° C. and 1 atmosphere. Standard temperature and pressure may also be referred to as “ambient conditions.” Unless indicated otherwise, parts are by weight, temperature is in ° C., and pressure is at or near atmospheric. The terms “elevated temperatures” or “high-temperatures” generally refer to temperatures of at least 100° C.

Unless otherwise specified, all percentages indicating the amount of a component in a composition represent a percent by weight of the component based on the total weight of the composition. The term “mol percent” or “mole percent” generally refers to the percentage that the moles of a particular component are of the total moles that are in a mixture. The sum of the mole fractions for each component in a solution is equal to 1.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

As used herein, the term “average size” refers to the particle size. The particle size of a spherical object can be unambiguously and quantitatively defined by its diameter. However, a typical material object is likely to be irregular in shape and non-spherical. There are several ways of extending the above quantitative definition to apply to non-spherical particles. Existing definitions are based on replacing a given particle with an imaginary sphere that has one of the properties identical with the particle. Volume-based particle size equals the diameter of the sphere that has the same volume as a given particle. Area-based particle size equals the diameter of the sphere that has the same surface area as a given particle. Weight-based particle size equals the diameter of the sphere that has the same weight as a given particle. Hydrodynamic or aerodynamic particle size equals the diameter of the sphere that has the same drag coefficient as a given particle.

As used herein, the term “mixing” refers to a unit operation in industrial process engineering that involves manipulation of a heterogeneous physical system with the intent to make it more homogeneous. Mixing is performed to allow heat and/or mass transfer to occur between one or more streams, components or phases.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by prior disclosure. Further, the dates of publication provided could be different from the actual publication dates that may need to be independently confirmed.

For molecules having isomers or exhibiting one or more chiral centers only one of the possible variations may be shown for the sake of brevity. A person having ordinary skill in the art will appreciate that disclosure of all such variations is intended. When a specific variation is preferred, this disclosure will so state.

### General Discussion

Various embodiments relate to methods of recycling produced water. One approach that could help the economics and drive costs down and make the process profitable is conversion of the inorganic wastes to useful materials.

Once most of the Group 2 divalents are removed from the mineral carbonation step, the resultant alkali chloride brine might be useful for pools or as a feedstock for the electrochemical production of chlorine, caustic, hypochlorite and hydrogen. Mixtures of group 2 oxides, hydroxide and carbonates could be used as aggregate within plastics, concrete, road materials or other construction materials. Separation of these materials into pure compositions is cost prohibitive preventing their production for use as a substitute for mined carbonate minerals.

Another factor making it difficult to make useful materials is that these minerals do not bond well with the matrix materials. This causes the materials to degrade the materials properties of the resultant materials rendering them useless for industrial applications. Properties could include strength, strength to weight and flexural properties. In addition, conversion of these minerals to useful materials must be low temperature (<180 degrees Celsius) to prevent release of the mineralized CO₂.

Various embodiments provide an integrated CCUS process that can convert CO₂ to Group 2 carbonates and subsequent encapsulation and sequestration process to convert the carbonates to commercially useful aggregate, useful in plastics, building materials, mineral boards, concrete and road materials and make a feedstock of water useful for carbon neutral or carbon negative chloralkali and green hydrogen manufacture.

### Produced Water Collection

A first step according to various embodiments may be the collection of produced waters. The produced waters typically have a total dissolved solids (TDS) content between 25,000 and 300,000 TDS. According to various embodiments, the produced water may come from a pipeline, directly from oil and gas operations or from an oil and gas separator, also known as a gun barrel. According to various embodiments, flow back may be rejected. As used herein, the term “flow back” refers to the return of the water originally used to hydraulically fracture the well. Flow back is typically the first water out of the well, followed by oil, gas, and geologic water. Flow back is often rejected because it may contain much of the chemistry used in the hydraulic fracturing fluid. These synthetic materials can be difficult to remove, and the initial water often does not contain many Group 2 ions. According to various embodiments, the produced water may contain greater than about 0.4% Ca and combined Group 2 ions. The produce water may also contain greater than about 50 ppm or greater than about 100 ppm of certain critical minerals. Critical minerals are a list of minerals designated by the US government as of strategic importance to the country. Advantageously, certain jurisdictions or companies may pay the operator of the process according to various embodiments to receive the produced water for treatment or disposal.

Pursuant to Executive Order 13817, on Feb. 16, 2018, the Secretary of the Interior published the draft list of critical minerals in the Federal Register (83 FR 7065). The draft list consisted of 35 minerals or mineral material groups deemed critical under the definition provided in the Executive Order: Aluminum (bauxite), antimony, arsenic, barite, beryllium, bismuth, cesium, chromium, cobalt, fluorspar, gallium, germanium, graphite (natural), hafnium, helium, indium, lithium, magnesium, manganese, niobium, platinum group metals, potash, the rare earth elements group, rhenium, rubidium, scandium, strontium, tantalum, tellurium, tin, titanium, tungsten, uranium, vanadium, and zirconium. Advantageously, certain jurisdictions or companies may pay the operator of the process according to various embodiments to receive the produced water.

Produced water may include a variety of alkaline earth metals, which include any element of Group 2 of the Periodic Table. More specifically, Beryllium (Be), Magnesium (Mg), Calcium (Ca), Strontium (Sr), Barium (Ba), and Radium (Ra). Table 1 provides an example of some, but not necessarily all, of the various components that may be present in produced water. The list above as well as the list of components in Table 1 are intended to include not only the elements that are listed, but also, where applicable, salts, acid derivatives, or peroxides formed therefrom. All amounts listed in Table 1 are given in parts-per million (ppm) which corresponds to milligrams (mg) of the component per liter (I) of aqueous solution (mg/l). As used in Table 1 and herein, the term “sulfate” refers to the sulphate ion having the formula SO₄²⁻ as well as to any salts, acid derivative, or peroxides of sulfate.

TABLE 1

| Parameters | Unit | Low TDS | Medium TDS | High TDS |
|---|---|---|---|---|
| pH | | 5.5 | 6.8 | 8 |
| Turbidity | NTU | 50-55 | 150 | 500 |
| Total dissolved | mg/L | ~25,000 | 150,000 | 300,000 |
| solids (TDS) | | | | |
| Total organic carbon | mg/L | 150 | 250 | 1000 |
| Dissolved organic carbon | mg/L | 120 | 150 | 1000 |
| Chloride | mg/L | 12000 | 60000 | 90000 |
| Bromide | mg/L | 120 | 650 | 950 |
| Sulfate | mg/L | 150 | 800 | 1200 |
| Total Alkalinity | mg/L | 180 | 900 | 1300 |
| as HCO3— | | | | |
| Barium | mg/L | 3 | 250 | 500 |
| Boron | mg/L | 5 | 20 | 100 |
| Calcium | mg/L | 1000 | 14000 | 20000 |
| Iron | mg/L | 10 | 40 | 100 |
| Lithium | mg/L | 1 | 100 | 500 |
| Magnesium | mg/L | 100 | 400 | 600 |
| Manganese | mg/L | 0.1 | 1 | 5 |
| Potassium | mg/L | 100 | 600 | 800 |
| Silicon | mg/L | 2 | 10 | 15 |
| Sodium | mg/L | 3000 | 35000 | 90000 |
| Strontium | mg/L | 50 | 300 | 900 |
| Sulfur as H2S | mg/L | 0 | 15 | 1500 |

It has been discovered that produced water is difficult to use or to recycle because it contains calcium and strontium and other divalent ions that form solid scale in most applications. Additionally, calcium removal from produced water yields solids that are often deemed to be commercially undesirable, because they are not pure in chemical composition or crystalline phase. For example, carbon capture through mineralization to carbonates of calcium and other divalent ions may be performed both in-situ and ex-situ or above ground. In this context, the term “in-situ” means within the geological formation, into which carbon dioxide (CO₂) may be injected. Similarly, “ex-situ” means that the produced water is removed from the geological formation and later treated with carbon dioxide. Both methods form carbonates of calcium and other divalent ions, but the difficultly and expense is in making the carbonates pure enough to use. Carbonates are usually not even useful as fillers or aggregates, because they do not adhere to many materials.

Overview of a Process for Producing a Mixed filler from Produced Water

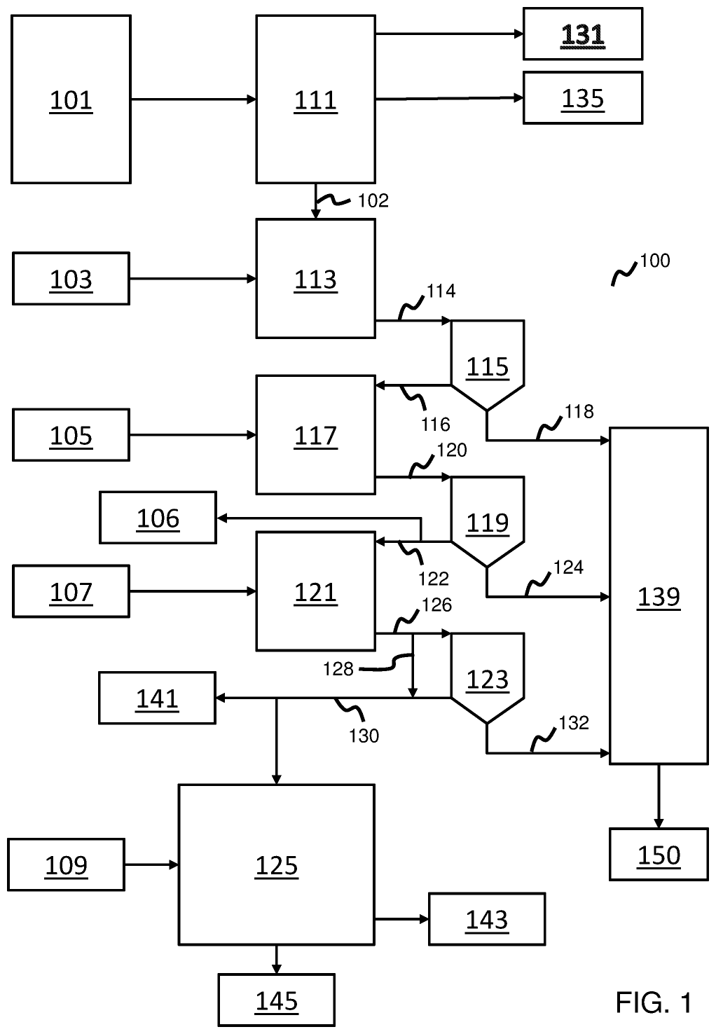

FIG. 1 is an example according to various embodiments, illustrating a schematic flow diagram of a process 100 for extracting various products from produced water 101, including a solids product 139, which may be subsequently utilized in an encapsulation and sequestration process 150. In general, the process 100 may include a pretreatment process 111, alkaline hydrolysis process 113, a softening and/or hardness removal process 117, a neutralization process 121, and a desalination process 125. A person having ordinary skill in the art will appreciate that each of processes or subprocesses may include any number of additional subprocesses, units, steps, or methods, and that these steps are illustrated in schematic form only for the sake of clarity and simplicity.

### Pretreatment Process

In process 100, produced water 101 may be fed to a pretreatment process 111. The pretreatment process 111, may include an oxidizing and/or a total suspended solids (TSS) removal process.

An oxidizing process may include but is not limited to introduction of oxidants like hypochlorous acid, sodium hypochlorite, chlorine, chlorine dioxide, permanganate, oxygen, hydrogen peroxide, and ozone. Oxidation may also be used to remove organics and some inorganic compounds like iron and manganese. According to various embodiments, it is possible to use an oxidizing filter that converts dissolved iron, manganese, and hydrogen sulfide to a solid form and then filters the particles out of the water. The filter may contain a suitable oxidizing media, such as, for example, manganese-treated green sand, a zeolite, plastic resin beads, or a silicon dioxide with a manganese dioxide coating.

TSS removal may proceed by any desired method, including but not limited to settling, separation, filtration, and combinations thereof. A settling process for TSS removal may allow suspended solids to settle out of the process water 101. A separation process may include any or all of a variety of methods, including but not limited to hydrodynamic separation, such as the use of a vortex or centrifugal force to separate suspended solids from the produced water 101. A separation process may also include passing the produced water 101 through a drainage network to separate suspended solids. A filtration process may pass the produced water 101 through any suitable filtration media. The filtration media may rely on physical, chemical, or biological processes to reduce separated solids. Non-limiting examples of filtration media include but are not limited to sand, soil, zeolites, or mechanical filters, screens, or meshes.

Often in produced water oil exists in an emulsified form where the emulsion particles are stabilized by naturally occurring charged species. Addition of oxidizer with react to decompose the stabilizing species. This can allow existing oil droplets to coalesce in a layer of oil or skim layer. The pretreatment process 111 can often produce enough skim oil that it is economically beneficial to collect it in a skimming process. The skim oil 131 may be salable to generate additional revenue from the process. If the skim oil 131 is produced in an amount of 0.1-0.5% by weight based on the total weight of the produced water stream, then it may be economically feasible to recover, to sell, or to otherwise use the skim oil 131. Some or all of the clear brine 137 may be used as discussed hereinafter.

The pretreatment process 111 may produce skim oil 131; clear brine source water 135 to produced water specification. For example, the pretreatment process 111 may be configured and operated to produce clear brine 137 targeting the produced Water Society's SPOT specifications, as shown in Table 2, which are the generally agreed to limits to be useful for hydraulic fracturing. The pretreatment process 111 may employ an electrochemically produced oxidizer. An example of an electrochemically produced oxidizer is a CHLOR-TECH™ unit available from DENORA™ or a membrane chloralkali chlorine and caustic plant. According to various embodiments, these systems may employ salt, such as salt from the mineral carbonation process, and electricity from other parts of the integrated process to minimize, to reduce, or to eliminate input of chemicals or energy.

TABLE 2

| Salinity | Reported | |
|---|---|---|
| pH | 6.0-8.0 | |
| Oxidation reduction | >350 | mV |
| Turbidity | <25 | NTU |

| | |
|---|---|
| Oil | <30 ppm - no sheen |
| Hydrogen Sulfide | Non-detectable |
| Particle Size | Filter <25 micron |

The pretreatment process 111 may also produce a bottoms product 102 that is produced at the bottom of the pretreatment process interaction. The bottoms product 102 may be fed to an alkaline hydrolysis process 113.

### Alkaline Hydrolysis Process

The alkaline hydrolysis process 113 may include introducing any suitable hydrolysis agent or catalyst 103. Alkaline hydrolysis is a well-known process whereby chemical bonds are broken by the insertion of water between the atoms in the bond. Alkaline hydrolysis can be catalyzed by enzymes, metal salts, acids, or bases. Bases are typically water solutions of alkali metal hydroxides such as sodium hydroxide (NaOH) or potassium hydroxide (KOH). According to various embodiments, heating the reactants may accelerate the hydrolysis reaction. The alkaline hydrolysis process 113 may destroy a variety of biological wastes and pathogens.

Additionally, the alkaline hydrolysis process 113 may prompt precipitation of Group 2 alkaline earth metal ions which form various insoluble compounds with carbonates, hydroxides and sulfates. The treated stream 114 from the hydrolysis process 113 may be fed to a first liquid/solid separation process 115, which may allow solid materials 118 to settle and to be collected as at least part of the solids product 139 that may be subsequently utilized in the encapsulation and sequestration process 150. The liquid product 116 from the first liquid/solid separation process 115 may be fed to a softening and/or hardness removal process 117.

Softening and/or Hardness Removal Process

The softening and/or hardness removal process 117 may include introducing a precipitation agent 105. The precipitation agent may be any agent that may prompt removal of Group 2 alkaline earth metal ions from the liquid product 116. Examples of precipitation agents include but are not limited to sodium carbonate (Na₂CO₃) and/or carbon dioxide (CO₂)). In high chloride containing brines, for example brines having greater than 20,000 tds, the pH may be maintained at >9.8 and as high as 12.5 to precipitate the Group 2 ions as carbonates. Below these pH's the calcium and strontium may remain in solution within the residence time of the treatment process.

As sodium carbonate is water-soluble and magnesium carbonate and calcium carbonate are insoluble, the former is used to soften water by removing Mg²⁺ and Ca²⁺. These ions form insoluble solid precipitates upon treatment with carbonate ions.

According to various embodiments, sodium carbonate may also be created by reacting CO₂ with caustic. Carbon dioxide may be supplied from the exhaust from any combustion process, including but not limited to frac pumps, generators, automobiles or from hydrogen production. Blue hydrogen, for example, is produced when natural gas is split into hydrogen and CO₂ either by Steam Methane Reforming (SMR) or Auto Thermal Reforming (ATR), but the CO₂ is captured, which mitigates environmental impacts. The ability to utilize CO₂ creates opportunities to convert gas normally flared to electricity and heat to a profitable process.

Since the fundamental principle of the softening and/or hardness removal process 117 relies on the insolubility of the divalent cations in the presence of carbonates to form minerals, a person having ordinary skill in the art would readily appreciate that many alternatives are possible. Such alternative approaches include but are not limited to using amines, gas bubblers, high pressure dissolved gas machines, a Solvay process and Leblanc process. The Solvay process is a major industrial process for the production of sodium carbonate. The Leblanc process was an early industrial process for making soda ash. Any method for producing and introducing or mixing the precipitation agent may be employed.

To aide in the precipitation process, flocculants may be added during the softening and/or hardness removal process 117. Flocculants, also known as flocculating agents or flocking agents, are chemicals that promote flocculation by causing colloids and other suspended particles in liquids to aggregate, forming a floc.

The softening and/or hardness removal process 117 may produce a stream 120 having 1 to 3% solids by weight. Stream 120 may be fed to a second liquid/solid separation process 119 in which the precipitated solids may be allowed to settle and removed as stream 124 to be collected as at least part of the solids product 139 that may be subsequently utilized in the encapsulation and sequestration process 150. The liquid stream 122 separated by the second liquid/solid separation process 119 may comprise water and one or more salts. This simple salt solution may comprise NaCl, Na₂SO₄, KCl, and LiCl. Some or all of the liquid stream 122 may also be collected or used as a partially desalinated brine 106, as discussed hereinafter. According to various embodiments, the liquid stream 122 solution will not possess any propensity to form solid scale.

Group 2 alkaline earth metals, like Ca, can permanently bind CO₂ as carbonates. This captures CO₂ and creates a pure NaCl brine that can be more easily used instead of disposed of, for example, as pool salt, weighted brine, or for chemical manufacturing inputs. Capturing the group 2 alkaline earth metals also makes the water much easier to desalinate for discharge in water distressed regions. Discharging the water would, therefore, have the potential to reduce the freshwater demand in water distressed regions.

### Neutralization Process

The liquid stream 122 may optionally be fed to neutralization process 121, in which it may be treated with an acid, such as hydrochloric acid (HCl). The neutralization process 121 may result in lowering the pH to a working range of 5.5-8.5. The resulting stream 126 of the neutralization process 121 may optionally be fed to a third liquid/solid separation process 123 in which the precipitated solids may be allowed to settle and removed as stream 132 to be collected as at least part of the solids product 139 that may be subsequently utilized in the encapsulation and sequestration process 150. Additionally, or alternatively as desired all or a portion of the stream 126 may be diverted, for example via stream 128. Stream 130 may include the liquid product of liquid/solid separation process 123 and/or the diverted stream 128. All or a portion of stream 130 may be collected as brine 141 for use as described hereinafter and/or fed to a desalination process 125. According to various embodiments, brine 141 is a monovalent brine solution with a density of between 8.5 and 11 ppg.

### Brine Usage

As discussed at various points, the process 100 may produce brine streams at multiple points, including clear brine 137, partially desalinated brine 106, and brine 141. Any or all of these brine streams may be valuable. The brine streams could be sold as a 10 pound/gallon, weighted brine. The brine could be used to operate a chloralkali plant. As part of a geothermal process the electricity would create salable chemicals, such as bleach, muriatic acid, chlorine, hydrogen gas and/or caustic, and would be carbon negative. As will be discussed, a chloralkali plant may produce some or all of the chemical inputs to softening and/or hardness removal process 117, thereby reducing costs. The brine could also be solar evaporated and sold as pool salt.

### Desalination Process

As previously mentioned, the process 100 may further comprise a desalination process 125. All or a portion of stream 130 may be fed to the desalination process 125. The desalination process may be employed to separate stream 130 into fresh water 143 and solids alkali salt 145. The water 143 may be reused in or sold for a variety of applications, such as agriculture, municipal, golf courses, or other industries. It could be discharged into ponds and streams. The solids alkali salt output 145 may be useful as pool and road salt. If it contained lithium, a low energy process such as froth flotation or ion exchange could be applied.

According to various embodiments, the desalination process 125 may be adapted to handle incoming bring streams having a total dissolved solids (TDS) of greater than 25,000-300,000 ppm TDS.

According to various embodiments, the desalination process 125 may be portable. According to various embodiments, the desalination process 125 may harness excess heat 109 from burners, climate and water post geothermal turbines.

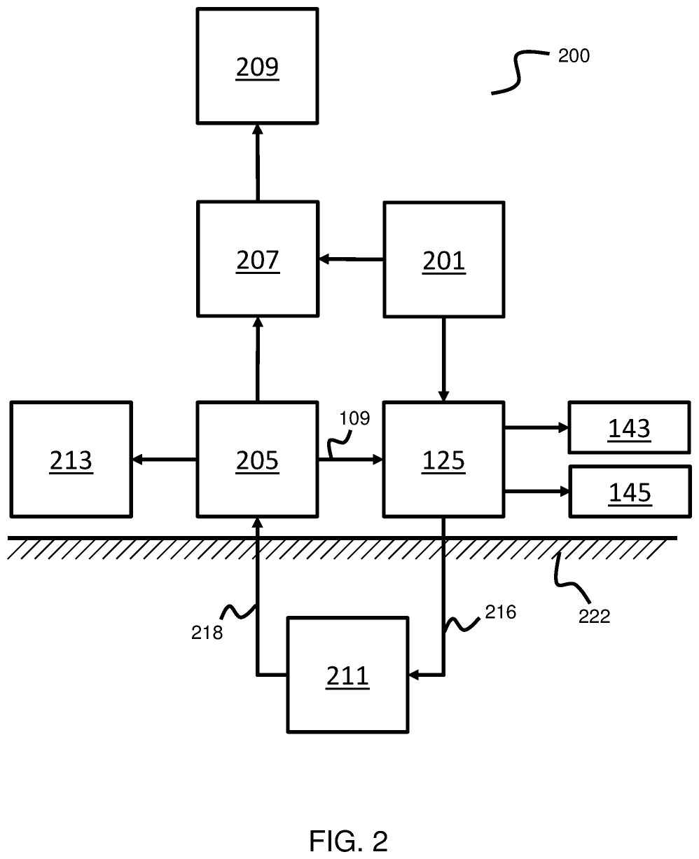

FIG. 2 is an example according to various embodiments, illustrating a schematic flow diagram of a desalination process 200 which may be employed in a process for producing a mixed filler from produced water. One or more brine streams 201 from the process 100 for producing a mixed filler from produced water, such as illustrated in FIG. 1 may be fed to the desalination process 125. As previously discussed, the desalination process 125 may produce fresh water 143 and a solids alkali salt output 145. The desalination unit may be supplied with heat 109, which may be supplied via hot (about 250 degrees Fahrenheit) water from a turbine and generator 205.

The hot water may provide heat to the desalination process 125 and then be ejected as cool water 216 to regain heat via a geothermal heating process 211. Hot water 218 from the geothermal heating process may then be resupplied to the turbine and generator 205 and the cycle may continue. Many of the formations in the United States have temperatures greater than 350 degrees Fahrenheit. The turbine and generator may also provide surplus electricity 213 that may be sold to the electric grid.

Finally, the turbine and generator may power a chloralkali plant 207. The chloralkali plant 207 may produce one or more products 209. The chloralkali process is a well-known industrial process for the electrolysis of sodium chloride solutions. It is the technology used to produce chlorine and sodium hydroxide. The one or more products 209 may include NaOH, bleach, chlorine, and/or hydrochloric acid. The process is commonly referred to salt splitting. As such, a chloralkali process may provide all the chemicals required in the integrated process. According to various embodiments, a financial break-even point may occur at usage rate of about 10 MT/day of chlorine. This would mean processing about 140,000 bbls of water per day. Depending on the formation, the solution such as the cool water stream 216 that is heated via the geothermal heating operation 211 could also be design for extraction of minerals that could be mined and used in green energy industries such as electric vehicles. The resulting salt stream could also be fed to the chloralkali plant for conversion into useful chemicals.

### Process Overview

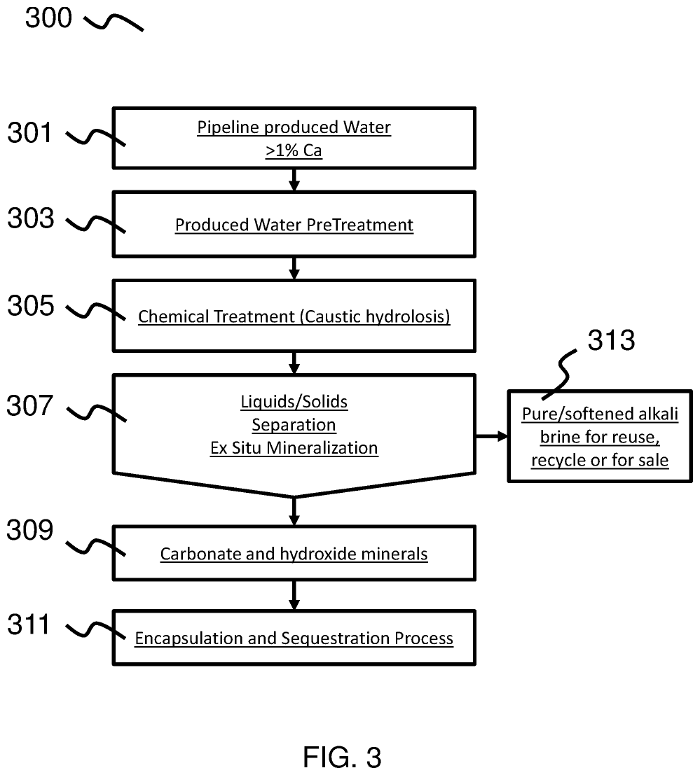

FIG. 3 is an example according to various embodiments, illustrating a schematic flow diagram of a process 300 for producing and using a mixed filler from produced water 301. The produced water may undergo a pretreatment process 303, corresponding to the pretreatment process 111 as shown in FIG. 1. Next, a chemical treatment process 305 may be employed. The chemical treatment process may include the hydrolysis process 113 as shown in FIG. 1. Next, a series of liquid/solid separations 307 may be performed. This process may also be considered to be an ex-situ mineralization because it is being conducted on produced water outside of a geological formation. The series of liquid solid separations 307 may correspond to or include processes 115, 117, 119, 121, and 123 as shown in FIG. 1. The series of liquid/solid separations 307 may yield pure/softened alkali brine 313 for reuse, recycle, or sale; and also a mixed filler 309 that may include carbonate and hydroxide mineral salts. The mixed filler 309 may be used in the encapsulation and sequestration process 311.

### Encapsulation and Sequestration Process

The encapsulation and sequestration process (150 in FIG. 1 or 311 in FIG. 3) is a process or a subprocess wherein a powder, platelet, fiber, or nanoparticle material may be coated with one or more inorganic siloxane resins designed to encapsulate the material with an impermeable high temperature, inorganic plastic layer that prevents the escape (leaching) of undesirable elements or compounds from the materials into the environment. The inorganic resin when cured, seals off the material from the environment, and provides a chemical bond to both the underlying particle and any type of organic plastic or inorganic resin that would subsequently be mixed with this material. The plastic encapsulating layer can range in thickness from roughly 1 micrometer up to one or more millimeters depending on the size of the particle, powder, or fiber to be coated.

The inorganic siloxane resins may be any of a family of specially formulated siloxane polymers (have a silicon-oxygen-silicon—Si—O—Si backbone). Conventional organic plastics and polymers have a carbon-carbon backbone. According to various embodiments, the Si—O—Si backbone of the inorganic siloxane resins may provide improved toughness and resilience in the encapsulating coating along with the ability to withstand over 600° F. (318° C.) for long periods. In addition, according to various embodiments, the cured siloxanes of the invention may resist being damaged when exposed ultraviolet light or sunlight. Additionally, the cured siloxanes according to various embodiments may be resistant to most commonly used solvents, as well as most common acids or bases, ensuring that the encapsulation layer will hold up in most environments.

According to various embodiments, the encapsulation and sequestration process may utilize some of the impurities in the mixed carbonate waste material to assist in the curing of the inorganic resin as well as enhance its adhesion to the mixed carbonate waste. Even in low amounts of about 10 to 100 parts per million, impurities such as boron, iron, manganese, cobalt, nickel, zinc, and tin present in the mixed carbonate waste stream may function as in-situ catalysts and bonding agents for the inorganic resin, assisting in the process of curing the inorganic resin to an encapsulation coating.

The encapsulation and sequestration process encapsulates the produced water waste solids preventing the escape of unwanted impurities such as barium, arsenic, selenium, beryllium, etc., which could improve the economics of desalination, critical mineral mining, and/or carbon negative chemical manufacturing. Eliminating the cost and environmental impact of disposal of the hazardous material is particularly beneficial. According to various embodiments, the encapsulation and sequestration process may encapsulate the mixed carbonate waste material from the produce water to yield a very low-cost feedstock for use with a variety of conventional materials such as polyolefin plastics, epoxies, and other engineering thermosetting or thermoplastic resins. The encapsulated mixed carbonate waste may bond to plastics, to concrete, and to other materials to function as a filler to give improved mechanical and thermal properties for the filled materials.

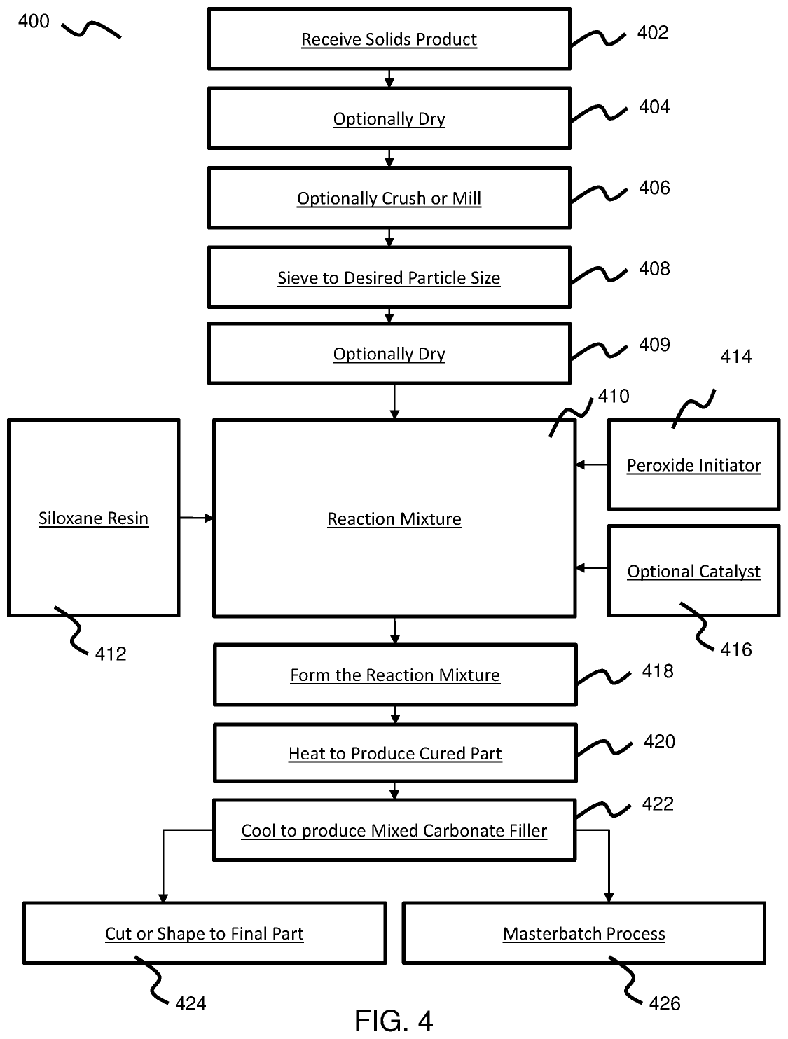

FIG. 4 is an example according to various embodiments, illustrating a first portion of an encapsulation and sequestration process 400 for producing a mixed filler from a solids product 139 obtained from produced water 101 and for using the mixed filler. The process 400 may include a step 402 of receiving a solids product, such as solids product 139 illustrated in FIG. 1. Depending on whether the solids produce 139 has already been dried, at step 404, the process 400 may include an optional step of drying the solids product. For example, according to various embodiments, the solids product may be dried at 90 to 120 degrees Celsius for 6 to 48 hours. At step 406, the process 400 may optionally include crushing or milling the dry or dried solids product. For example, the solids product may be crushed or milled to have a maximum particle size of less than 1 to 2 mm. At step 408, the process 400 may include sieving the solids product to arrive at a particle mixture, wherein the particle mixture comprises 15 to 55% by mass of particles sized at less than 45 micrometers. According to various embodiments, the particle mixture may also optionally include 45 to 85% by mass of particles sized at less than 355 micrometers. At step 409, the particle mixture may optionally be dried for 0.5 to 24 hours at 115 to 145° C.

The final particle mixture may be added to a reaction mixture 410 in addition to a siloxane resin 412, a peroxide initiator 414, and optionally a catalyst 416. The reaction mixture 410 may be prepared by mixing the components. The particle mixture may be present in an amount of from 60 to 95% by mass of the reaction mixture. The siloxane resin may be present in an amount of from 5 to 40% by mass of the reaction mixture. The siloxane resin may be any suitable siloxane resin, such as methylphenyl vinyl siloxane resin, for example. The peroxide initiator may be added to the reaction mixture at 1 to 3 parts per hundred weight (phr) of the resin. The catalyst may be an organic metallic catalyst, such as an organo-metallic catalyst comprising one or more of the following metals: zinc, cobalt, tin, manganese, boron, iron, and combinations thereof. The catalyst may be added to the reaction mixture at 0 to 2 phr of the resin.

At step 418, the process 400 may include forming the reaction mixture to produce a preform. According to various embodiments, the forming may comprise molding, extruding, pressing, 3D printing, casting, or combinations thereof. The pressing may be conducted at a pressure of 0 to 200 psi.

At step 420, the process 400 may include heating the preform to produce a cured part. The heating may comprise multiple heating stages, such as, for example a first stage, an optional second stage, an optional third stage, an optional fourth stage, and an optional fifth stage. The heating may be conducted under inert gas such as nitrogen or under air. The first stage of the multiple heating stages may comprise heating the preform for 0.5 to 6 hours at 100 to 115 degrees Celsius. The optional second stage of the multiple heating stages may comprise heating the preform for 0.5 to 6 hours at 130 to 140 degrees Celsius. The optional third stage of the multiple heating stages may comprise heating the preform for 0.5 to 6 hours at 155 to 180 degrees Celsius. The optional fourth stage of the multiple heating stages may comprise heating the preform for 1 to 4 hours at 200 to 220 C degrees Celsius. The optional fifth stage of the multiple heating stages may comprise heating the preform for 1 to 4 hours at 240 to 280 degrees Celsius.

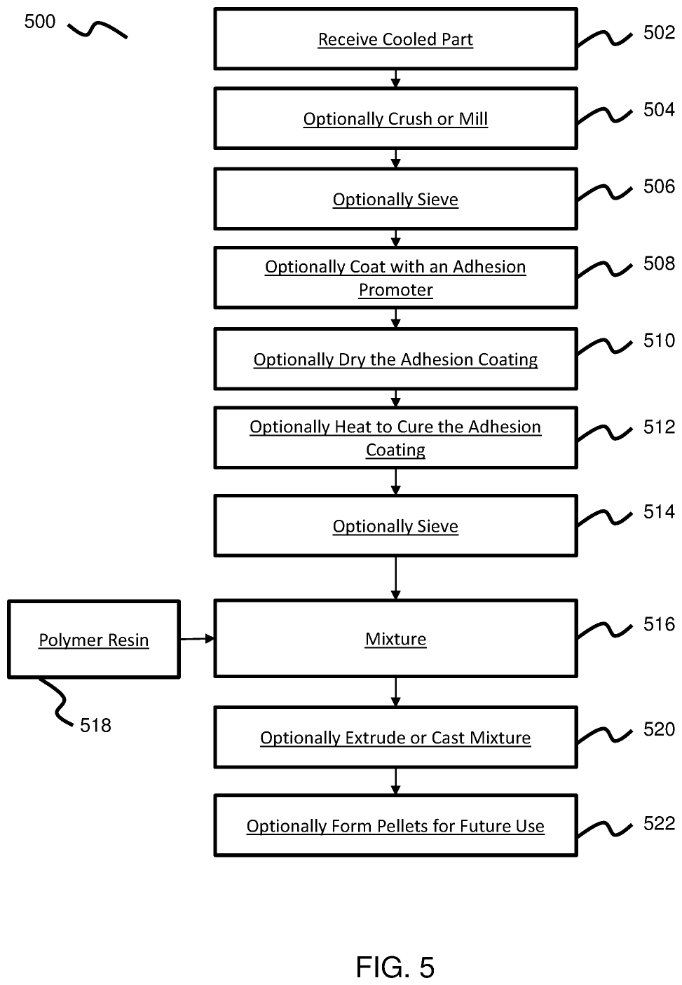

At step 422, the process 400 may include cooling the cured part to room temperature. The cured and cooled part may optionally be cut or shaped into a final part at step 424. Additionally or alternatively, the cured and cooled part may be further process in a master batch process 426, an example of which is illustrated in FIG. 5.

FIG. 5 is an example according to various embodiments, illustrating a second continuing portion of the encapsulation and sequestration process illustrated in FIG. 4, detailing the use of the mixed filler in an exemplary masterbatch process 500. At step 502, the masterbatch process 500 may include receiving a cooled and cured part, such as is produced in process 400. At step 504, the cooled and cured part may optionally be crushed or milled to a particle size less than 100 microns, or preferably less than 45 microns, to form a crushed mixed carbonate. At step 506, the masterbatch process 500 may include an optional step of sieving the crushed mixed carbonate to ensure that any desired size is maintained. At step 508, the process 500 may optionally include coating the crushed mixed carbonate with an adhesion promoter. At step 510, the adhesion promoter may optionally be allowed to dry. Additionally or alternatively, at step 512, the adhesion promoter may be heated and cured. The adhesion promoters/coupling agents may include but are not limited to VTES, aminopropylsilanes, or other coupling agents used to coat inorganic fillers such as commercial grade calcium carbonate. At step 512, the optionally coated mixed carbonate may optionally be sieved again to ensure that any desired particle size is maintained.

At step 516, a mixture may be formed by mixing 5 to 60% by mass of the crushed material with 40 to 95% by mass of a polymer resin. The polymer resin may be a thermoplastic or thermosetting polyolefin, such as, for example, polypropylene. At step 520, the mixture may optionally be extruded or cast. Finally, at step 522, the mixture bay be pelletized for future use.

### EXAMPLES

### Introduction

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Example 1

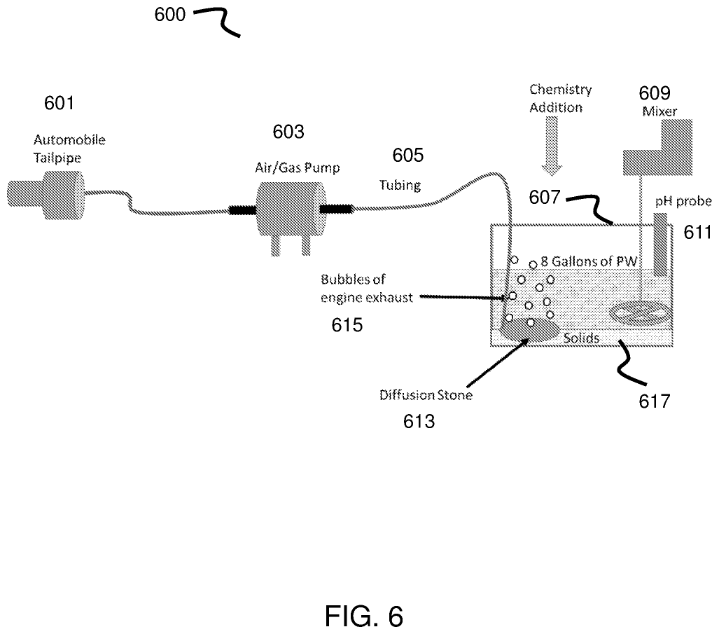

FIG. 6 is an example according to various embodiments, illustrating a schematic diagram of an equipment configuration 600 used in an experimental test of a liquid/solids separation of produced water. An air/gas pump 603 was connected to an automobile tailpipe 601. The pump 603 pumped the exhaust through tubing 605 and into a tank 607 containing 8 gallons of produced water via a diffusion stone 613. Bubbles 615 of the exhaust gas passed through the diffusion stone and rose through the produced water, which was agitated via a mixer 603. A pH probe 611 was used to measure the pH of the produced water at various stage. Chemicals were added as specified below directly to the tank 607. Solids 617 that precipitated from the produced water were allowed to settle to the bottom of the tank 607.

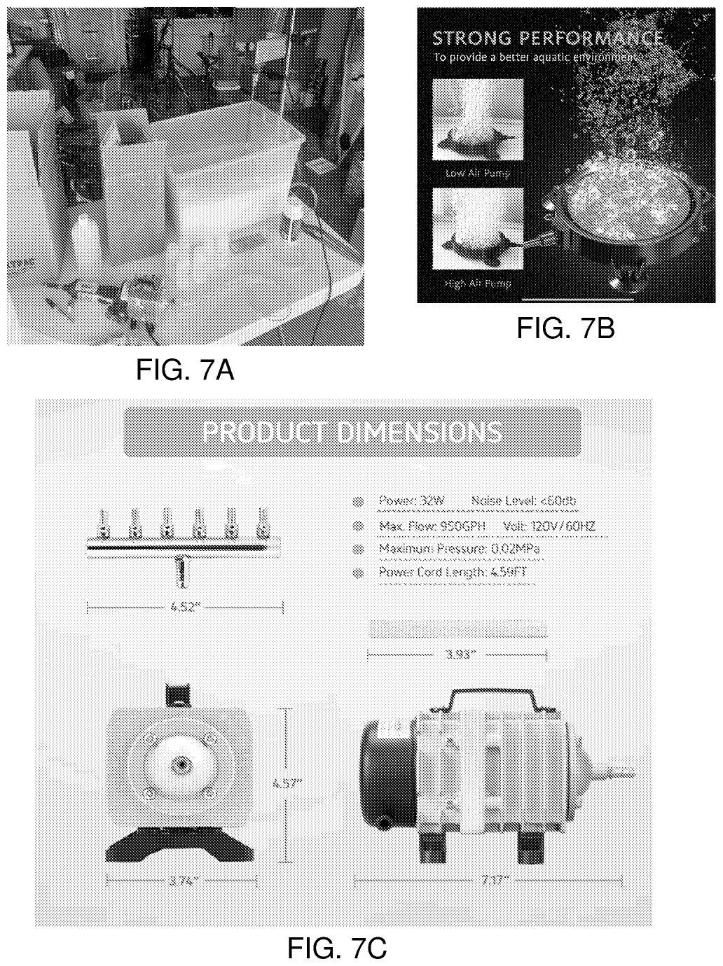

FIG. 7A is an example according to various embodiments, illustrating a photograph of an experimental setup for the example presented herein. FIG. 7B is an example according to various embodiments, illustrating a photograph of an air diffuser used in the example presented herein. FIG. 7A is an example according to various embodiments, illustrating a photograph of a specification sheet for an air/gas pump used in the example presented herein. The air/gas pump 603 was a commercial air pump manufactured by VIVOSUN™ available from AMAZON™. The pump 403 had the following specifications: Power: 32 W; Max Flow 950 g/h; Volt: 120V/60 Hz; and Maximum Pressure 0.02 MPa.

### Experimental Procedure

Eight (8) gallons of produced water provided by an operator in the Haynesville Shale of East Texas was transferred to a plastic tank. The tank was set up with a mixer and an air diffuser stone. A tube was connected from the stone to a gas pump which was then inserted into the tailpipe of a running automobile. This meant that 100% of the gas being diffused through the stone was automobile exhaust. The primary components would have been air, carbon dioxide and water vapor. This was the source of carbon dioxide.

Analysis of the solution or brine phase was carried out. Characterization of the pH and elemental composition was run. This data obtained is summarized in Table 1.

Step 1: The preliminary produced water was analyzed. The composition of the water at this step is described in Table 3.

Step 2: Hydrolysis or hydroxide treatment was performed. Next the mixer was turned on and the pH was adjusted to 12. This step is described as a “hydrolysis step” in that excess hydroxide was added. A white precipitate was formed which would be primarily insoluble Mg(OH)₂ or magnesium hydroxide. This is supported by the water analysis where only the concentration of Mg was reduced from 800 ppm to almost 0 ppm.

Step 3: A carbon dioxide reaction was performed. Next the pump was started with the inflow from the exhaust of a running automobile. The mixer and bubbler were going. The pH was observed to drop from 12 to approximately 9.8 due to the formation of carbonic acid that then reacted with the Ca and Sr to form the carbonate minerals. This is supported by the fact that the concentrations of these ions reduced from 14,000 to 5500 ppm and 5600 to 3400 ppm, respectively.

Step 4: Calcium and strontium carbonate mineral formation was allowed to proceed to completion. The pH was raised to 12.5 and the exhaust was allowed to run. NaOH was added six (6) times to maintain the high pH. After three (3) hours the experiment was stopped. The calcium and strontium levels at this point were very low.

TABLE 3

| | Step 1 | Step 2 | Step 3 | Step 4 |
|---|---|---|---|---|
| Analyte or | Conc. (mg/L | Conc. (mg/L | Conc. (mg/L | Conc. (mg/L |
| Measurement | or ppm) | or ppm) | or ppm) | or ppm) |
| pH | 5.35 | 11.5 | 9.8 | 12.5 |
| TDS | 157,221 | 165,723 | 163,829 | 184900 |
| Conductivity | 185,800 | 187,300 | 192,600 | 193000 |
| (microohms/ | | | | |
| cm2) | | | | |
| Ca + 2 | 14,110 | 14,568 | 5515 | 18 |
| Mg + 2 | 825 | 0 | 0 | 0 |
| Na+ | 43,095 | 45,559 | 56077 | 66150 |
| Sr + 2 | 6212 | 6211 | 3362 | 47.8 |
| Cl— | 100,110 | 98,107 | 98708 | 97106 |

### Example 2

A purpose of this example is to demonstrate a structural panel made with mixed carbonate waste and inorganic polymer resin. In this case, the encapsulation and sequestration process is carried to the extreme of having the encapsulation resin be the entire “plastic matrix” instead of just a thin coating on the mixed carbonate waste particles.

The approximately 60% solids in water mixture of carbonates are allowed to settle for 24 hours and the water layer was decanted off the top.

The mud-like material was then poured onto a shallow pan (½ inch in depth) and dried over 24 hours by heating to 95° C. in a mechanical convection oven. Once the visible water was removed, the material was heated at 2° C. to 170° C. to remove adsorbed volatiles and residual moisture.

The very hard, brittle mixed carbonate material was then broken up into fine powder using a chain mill and sieved through 355 micrometer and 45 micrometer sieves using a RO-TAP™ sieve shaker running for 15 minutes.

The fractions that passed through the 45-micrometer sieve and the 355-micrometer sieve were saved, the larger material was set aside for use in other applications such as cement filler, or to be ball milled down to under 355 micrometers.

The two mixed carbonate particle size ranges were mixed at a ratio of 75% of the less than 355/greater than 45 micrometer (industry designation “−355/+45” micrometer) powder with 25% of the less than 45 micrometer powder (industry designation “−45” micrometer). This ratio was dried for 1 hour at 105° C. to remove adsorbed moisture and mixed with catalyzed siloxane-based inorganic resin. The inorganic resin was a methylphenyl vinyl siloxane resin catalyzed with a commercial peroxide initiator called LUPEROX™ 531. The resin and mixed carbonate powder were mixed in a 75% mixed carbonate powder/25% resin ratio by mass. The resin and powder were mixed thoroughly using a commercial “kitchen aid” type planetary mixer for 10 minutes. Once mixed, the clay-like material was placed in a PTFE coated 5″×3″ mold aluminum mold. Enough of the clay-like mix was added to produce a 0.25″ thick plate. The mix was leveled and then pressed in a 6-inch×6″ platen Carver Platen Press to a pressure of 150 pounds per square inch (psi). The plate was then removed from the mold and heated under nitrogen to cure the resin. The heating profile was 4 hours at 110° C. followed by 4 hours at 135° C., followed by 4 hours at 160° C. The plate was then allowed to cool in the oven to near room temperature. Once cool the plate was cut into flexure bars using a SHAPEKO™ router system and the bars were tested in 3-point flexure mode on a Test Resources Universal Test System. The applied load was measured, and the stress was calculated. The flexure strength averaged 3,012 psi which is comparable with high priced commercial fiber reinforced cement siding and other plastic based mineral-filled siding.

This example is not intended to be limiting. Many variations will be readily apparent to a person having ordinary skill in the art. The range of particle sizes may, for example, range from 5 millimeter down to nano-powders (under 0.1 micron) and any mixtures of particles within that size range. The mass percentage of mixed carbonate filler may range from 1% (colorant in the resin) to 85% (to make a filter) with the rest being the inorganic resin. The curing time and temperature may range from 2 hours at 135° C. to 4 hours at 335° C. The atmosphere may be air, nitrogen, or another inert gas. Curing agents for the resin coating may be any commercially available peroxide initiator with a 10-hour half-life of 90° C. to 140° C. The curing agents may be used at a 0.5 to 3 phr range (per hundred weight of resin).

### Example 3

A purpose of this example is to demonstrate utilizing mixed carbonate waste in polyolefins such as polypropylene.

The approximately 60% solids in water mixture of carbonates were allowed to settle for 24 hours and the water layer was decanted off the top.

The mud-like material was then poured onto a shallow pan (½ inch in depth) and dried over 24 hours by heating to 95° C. in a mechanical convection oven. Once the visible water was removed, the material was heated at 2° C. to 170° C. to remove adsorbed volatiles and residual moisture.

The very hard, brittle mixed carbonate material was then broken up into fine powder using a chain mill and sieved through 355 micrometer and 45 micrometer sieves using a RO-TAP™ sieve shaker running for 15 minutes.

The fractions that passed through the 45-micrometer sieve and the 355-micrometer sieve were saved, the larger material was set aside for use in other applications such as cement filler, or to be ball milled down to under 355 micrometers.

The 45 micrometer and smaller sized powders (industry designation “−45” micrometer) were coated with a dilute solution of a vinylmethylphenyl siloxane polymer designated “B184.” The dilute solution consisted of 3 grams of the siloxane polymer previously catalyzed with 1 phr (parts per hundred weight of resin) of dibutyltindilaurate and 2 phr of dicumyl peroxide mixed with 30 grams of reagent grade acetone from Sigma Aldrich. The dilute solution was mixed at a ratio of 100 grams of −45-micron mixed carbonate powder to 28 grams of the dilute 10% resin solution in acetone described above. The resin solution and powder were mixed in a polypropylene plastic cup using a metal stirring spatula until the powder was completely wetted out with the resin solution. The coated powder was allowed to air dry at room temperature overnight and then heated to partially cure and harden the polymer coating on the powders. The heating cycle was in nitrogen and consisted of a soak at 115 degrees Celsius for 2 hours followed by a 45-minute soak at 135 degrees Celsius. This partially cured the resin but still left active vinyl groups to bond into other resin systems.

The partially coated powder was sieved through a 45-micron sieve using the RO-TAP™ sieve shaker as above. The coated powder passing through the sieve was used as filler in polypropylene. 32 grams of polypropylene powder was mixed with 32 grams of the coated mixed carbonate powder and tamped into a Teflon-coated aluminum pan. The pan was placed in a vacuum oven set at 160 degrees Celsius and the oven was evacuated and backfilled with nitrogen. The setpoint was set to 200 degrees Celsius and the material heated under nitrogen until the temperature reached 175 degrees Celsius, at which time the oven was evacuated to a vacuum of >−700 torr and held until after the polypropylene/mixed carbonate mixture melted into a somewhat fluid material. Once the material was molten for 45 minutes and the temperature was at 200° C., the oven was backfilled to atmospheric pressure with nitrogen and the oven setpoint was set to 80 degrees Celsius. The plate was allowed to cool in the oven (roughly 6 hours) and then removed and inspected.

Once cool the plate was cut into flexure bars using a SHAPEKO™ router system and the bars were tested in 3-point flexure mode on a Test Resources Universal Test System. The applied load was measured, and the stress was calculated. The flexure strength averaged 3,931 psi which is significantly higher than the flexure strength of 50% filled polypropylene where the filler is high purity commercial calcium carbonate (coated with an expensive coupling agent) and comparable in strength to unmodified polypropylene. However, the flexural modulus was nearly 2× of unmodified polypropylene. Normally fillers such as calcium carbonate decrease the strength significantly at 50% mass loading, but in this case the strength was comparable to unfilled polypropylene. This example demonstrates that the unmodified, un-purified mixed carbonate material can replace higher cost, higher purity fillers in polyolefins such as polypropylene when the mixed carbonate material is encapsulated in a thin layer <2 micrometers) of a specially tailored, low-cost inorganic resin coating that bonds to the polypropylene.

This example is not intended to be limiting. Many variations will be readily apparent to a person having ordinary skill in the art. The size of mixed carbonate resin particles in the invention may, for example, range from 100 microns down to nanometer size with less than 45 microns preferred and less than 10 microns most preferred. The encapsulation coating thickness in the invention may range from 0.25 microns on submicron powders to up to 10 microns on 100-micron powders. The mass percentage of coated mixed carbonate waste filler in the plastics in the invention may range from 10% to 70% depending on the median particle size and coating thickness. The curing time and temperature for the coating may range from 4 hours at 110° C. to 4 hours at 150° C. depending on the type of curing agent used. The curing agents may be used at a 0.5 to 3 phr range (per hundred weight of resin). Curing agents for the resin coating may be any commercially available peroxide initiator with a 10-hour half-life of 90° C. to 140° C. The processing temperature for the casting of the part may range from 185° C. for 3 hours to 210° C. for 1 hour and depends on the amount of coated mixed carbonate filler used. More filler requires higher temperatures for flow. Curing/rheology modification agents for the polypropylene may include Dicumyl Peroxide, LUPEROX™ 101, and LUPEROX™ 130.

### Example 4

A purpose of this example was to demonstrate using coated mixed carbonate filler in a polyolefin (polypropylene) masterbatch.

The approximately 60% solids in water mixture of carbonates were allowed to settle for 24 hours and the water layer was decanted off the top.

The mud-like material was then poured onto a shallow pan (½ inch in depth) and dried over 24 hours by heating to 95° C. in a mechanical convection oven. Once the visible water was removed, the material was heated at 2° C. to 170° C. to remove adsorbed volatiles and residual moisture.

The very hard, brittle mixed carbonate material was then broken up into fine powder using a chain mill and sieved through 355 micrometer and 45 micrometer sieves using a RO-TAP™ sieve shaker running for 15 minutes.

The fractions that passed through the 45-micrometer sieve and the 355-micrometer sieve were saved, the larger material was set aside for use in other applications such as cement filler, or to be ball milled down to under 355 micrometers.

The 45 micrometer and smaller sized powders (industry designation “−45” micrometer) were coated with a dilute solution of a vinylmethylphenyl siloxane polymer designated “B184” The dilute solution consisted of 3 grams of the siloxane polymer previously catalyzed with 1 phr (parts per hundred weight of resin) of dibutyltindilaurate and 8 phr of dicumyl peroxide mixed with 120 grams of reagent grade acetone from Sigma Aldrich. The dilute solution was mixed at a ratio of 500 grams of −45-micron mixed carbonate powder to 112 grams of the dilute 10% resin solution in acetone described above. The resin solution and powder were mixed in a 2000 ml polypropylene beaker using a metal stirring spatula until the powder was completely wetted out with the resin solution. The coated powder was allowed to air dry at room temperature overnight and then heated to partially cure and harden the polymer coating on the powders. The heating cycle was in nitrogen and consisted of a soak at 115 degrees Celsius for 2 hours followed by a 45-minute soak at 135 degrees Celsius. This partially cured the resin but still left active vinyl groups to bond into other resin systems.

The partially coated powder was sieved through a 45-micron sieve using the RO-TAP™ sieve shaker as above. The coated powder passing through the sieve was used as filler in polypropylene.

In this case, the coated mixed carbonate powder is mixed with the polypropylene powder at a 40% coated powder to 60% polypropylene mass ratio. 500 grams of the mix was fed into a screw extruder with the barrel heated to 180 degrees Celsius and the nozzle set at 190 degrees Celsius. The mixed material was extruded into a 3 mm diameter filament that cooled in a water bath and then fed into a chopper unit that produced pellets from the filament. These pellets were then used as a “masterbatch” feedstock for the extrusion of components such as rods and bar stock from the mixed carbonate filled polypropylene.

This example is not intended to be limiting. Many variations will be readily apparent to a person having ordinary skill in the art. The size of mixed carbonate resin particles in the invention may, for example, range from 100 microns down to nanometer size with less than 45 microns preferred and less than 10 microns most preferred. The encapsulation coating thickness in the invention may range from 0.25 microns on submicron powders to up to 10 microns on 100-micron powders. The mass percentage of coated mixed carbonate waste filler in the plastics in the invention may range from 10% to 70% depending on the median particle size and coating thickness. The curing time and temperature for the coating may range from 4 hours at 110° C. to 4 hours at 150° C. depending on the type of curing agent used. The curing agents may be used at a 0.5 to 3 phr range (per hundred weight of resin). Curing agents for the resin coating may be any commercially available peroxide initiator with a 10-hour half-life of 90° C. to 140° C. The processing temperature for extruding the material may range from 140° C. to 190° C. and depends on the amount of coated mixed carbonate filler used. More filler typically requires higher temperatures for flow. Curing/rheology modification agents for the polypropylene may include Dicumyl Peroxide, LUPEROX™101, and LUPEROX™130

### Example 5

A purpose of this example was to demonstrate using mixed carbonate waste coated with a commercial coupling agent/adhesion promoter coating as filler in a polyolefin (polypropylene) masterbatch.

The approximately 60% solids in water mixture of carbonates were allowed to settle for 24 hours and the water layer was decanted off the top.

The mud-like material was then poured onto a shallow pan (½ inch in depth) and dried over 24 hours by heating to 95° C. in a mechanical convection oven. Once the visible water was removed, the material was heated at 2° C. to 170° C. to remove adsorbed volatiles and residual moisture.

The very hard, brittle mixed carbonate material was then broken up into fine powder using a chain mill and sieved through 355 micrometer and 45 micrometer sieves using a RO-TAP™ sieve shaker running for 15 minutes.

The fractions that passed through the 45-micrometer sieve and the 355-micrometer sieve were saved, the larger material was set aside for use in other applications such as cement filler, or to be ball milled down to under 355 micrometers.

The 45 micrometer and smaller sized powders (industry designation “−45” micrometer) were coated with a dilute solution of a Vinyltriethoxysilane (VTES) from Gelest. The dilute solution consisted of 3 grams of VTES previously catalyzed with 1 phr (parts per hundred weight of resin) of dibutyltindilaurate and 8 phr of dicumyl peroxide mixed with 120 grams of reagent grade acetone from Sigma Aldrich. The dilute solution was mixed at a ratio of 500 grams of −45-micron mixed carbonate powder to 112 grams of the dilute 10% resin solution in acetone described above. The resin solution and powder were mixed in a 2000 ml polypropylene beaker using a metal stirring spatula until the powder was completely wetted out with the resin solution. The coated powder was allowed to air dry at room temperature overnight and then heated to partially cure and harden the polymer coating on the powders. The heating cycle was in nitrogen and consisted of a soak at 115 degrees Celsius for 2 hours followed by a 45-minute soak at 135 degrees Celsius. This partially cured the resin but still left active vinyl groups to bond into other resin systems.

The partially coated powder was sieved through a 45-micron sieve using the RO-TAP™ sieve shaker as above. The coated powder passing through the sieve was used as filler in polypropylene.

In this case, the coated mixed carbonate powder is mixed with the polypropylene powder at a 40% coated powder to 60% polypropylene mass ratio. 500 grams of the mix was fed into a screw extruder with the barrel heated to 180 degrees Celsius and the nozzle set at 190 degrees Celsius. The mixed material was extruded into a 3 mm diameter filament that cooled in a water bath and then fed into a chopper unit that produced pellets from the filament. These pellets were then used as a “masterbatch” feedstock for the extrusion of components such as rods and bar stock from the mixed carbonate filled polypropylene.

The size of mixed carbonate resin particles in the invention ranges from 100 microns down to nanometer size with less than 45 microns preferred and less than 10 microns most preferred

The commercially available adhesion promoters/coupling agents that could be used in the invention include but are not limited to VTES, aminopropylsilanes, or other coupling agents used to coat inorganic fillers such as commercial grade calcium carbonate.

This example is not intended to be limiting. Many variations will be readily apparent to a person having ordinary skill in the art. The encapsulation coating thickness in the invention may range from 0.25 microns on submicron powders to up to 10 microns on 100-micron powders. The mass percentage of coated mixed carbonate waste filler in the plastics in the invention may range from 10% to 70% depending on the median particle size and coating thickness. The curing time and temperature for the coating may range from 4 hours at 110° C. to 4 hours at 150° C. depending on the type of curing agent used. The curing agents may be used at a 0.5 to 3 phr range (per hundred weight of resin). Curing agents for the resin coating may be any commercially available peroxide initiator with a 10-hour half-life of 90° C. to 140° C. The processing temperature for extruding the material may range from 140° C. to 190° C. and depends on the amount of coated mixed carbonate filler used. More filler typically requires higher temperatures for flow. Curing/rheology modification agents for the polypropylene may be Dicumyl Peroxide, LUPEROX™ 101, and LUPEROX™ 130

### Example 6

A purpose of this example was to demonstrate masterbatches using commercial polypropylene pellets.

The encapsulated mixed carbonate waste was prepared as in previous examples to result in encapsulated mixed carbonate powder of a size less than 45 microns. The encapsulated powder was then mixed with commercially available polypropylene pellets at a mass ratio of 400 grams of coated powder to 600 grams of polypropylene pellets.

The mix of powder and pellets was fed into a single screw extruder with the barrel temperature set to 175° C. and the head temperature of 185° C. The extruded 3 mm filament was then cooled in a water bath and then fed into a chopper unit to cut the filament into small pellets of a size comparable to the original polypropylene pellets. Once all the material was converted to pellets of encapsulated mixed carbonate fillet polypropylene, the pellets were then fed into the same extruder set at the same temperatures and the process to make pellets was repeated. This sequence was done 3 more times for a total of 5 runs through the extruder. At the end of the 5 runs, the filler was uniformly mixed with the polypropylene based on microscopic examination. These pellets could function as a master batch for making components from encapsulated mixed carbonate waste filled polypropylene.

In an industrial setting, a twin-screw mixing extruder/pelletizer may be used to produce the master batch pellets in a single run instead of the 5 runs needed with a short, single screw extruder.

What is claimed is:

1. A method comprising:
obtaining a solids product from produced water, the solids product comprising at least one carbonate of a Group 2 alkaline earth metal;
mixing the solids product with a siloxane resin to produce a reaction mixture;
forming the reaction mixture to produce a preform; and
heating the preform to cure the siloxane resin.

2. The method of claim 1, wherein the reaction mixture comprises
60 to 95% by mass of the solids product, and
5 to 40% by mass of the siloxane resin.

3. The method of claim 1 or 2, wherein the reaction mixture comprises a peroxide initiator in an amount of 1 to 3 parts per hundred weight of the siloxane resin.

4. The method of any of claims 1-3, wherein the reaction mixture comprises an organo-metallic catalyst in an amount of 0 to 2 parts per hundred weight of the siloxane resin

5. The method of claim 4, wherein the organo-metallic catalyst comprises one or more of zinc, cobalt, tin, manganese, boron, or iron.

6. The method of any of claims 1-5, wherein forming the reaction mixture comprises one or more of molding, extruding, pressing, 3D printing, or casting.

7. The method of any of claims 1-6, further comprise drying the solids product at 90 to 120 degrees Celsius for 6 to 48 hours.

8. The method of any of claims 1-7, further comprising crushing or milling the solids product to a particle size less than 1 to 2 mm.

9. The method of any of claims 1-8, wherein the solids product comprises 15 to 55% by mass of particles sized at less than 45 micrometers; and optionally 45 to 85% by mass of particles sized at less than 355 micrometers.

10. The method of any of claims 1-9, wherein heating the preform comprises:
a first stage comprising heating the preform for 0.5 to 6 hours at 100 to 115 degrees Celsius,
optionally a second stage comprising heating the preform for 0.5 to 6 hours at 130 to 140 degrees Celsius,
optionally a third stage of the multiple heating stages comprises heating the preform for 0.5 to 6 hours at 155 to 180 degrees Celsius,
optionally a fourth stage of the multiple heating stages comprises heating the preform for 1 to 4 hours at 200 to 220 degrees Celsius, and
optionally a fifth stage of the multiple heating stages comprises heating the preform for 1 to 4 hours at 240 to 280 degrees Celsius.

11. The method of any of claims 1-10, wherein heating the preform to cure the siloxane resin results in a cured part, and wherein the method further comprises cutting or shaping the cured part to produce a final part.

12. The method of any of claims 1-10, wherein heating the preform to cure the siloxane resin results in a cured part, and wherein the method further comprises:
crushing or milling the cured part to a particle size less than 100 microns to produce a crushed mixed carbonate,
mixing the crushed mixed carbonate with a polymer resin to produce an encapsulated mixed carbonate.

13. The method of claim 12, wherein the encapsulated mixed carbonate comprises mixing 5 to 60% by mass of the crushed mixed carbonate and 40 to 95% by mass of the polymer resin.

14. The method of claim 12, further comprising one or more of casting, extruding, or pelletizing the encapsulated mixed carbonate.

15. A method of removing carbon dioxide from a gas stream comprising the steps of
a. obtaining an aqueous geological solution contain one or more group 2 divalent cations;
b. admixing a group 1 hydroxide base with the aqueous geological solution to raise the pH to 9 or greater and maintain pH throughout the process;
c. admixing a gas stream with the product of (b) containing carbon dioxide to form solid group 2 hydroxides and carbonates;
d. removing the solids that are formed from the solution;
e. drying the solids;
f. grinding the solids;
g. admixing the solids with a siloxane resin to produce a reaction mixture;
h. forming the reaction mixture to produce a preform; and
i. heating the preform to cure the siloxane resin.

16. The method of claim 15 where the aqueous geological solution contains at least 2 group 2 divalent cations.

17. The method of claim 15 or 16, where the aqueous geological solution contains at least 1% Calcium ions by mass.

18. The method of claim 15 where the aqueous geological solution contains at least 0.5% Calcium ions by mass and 0.01% one other group 2 divalent cation.

19. The method of any of claims 15-17 where the pH is raised and maintained greater than 10.

20. The method of any of claims 15-19 where the pH is raised and maintained greater than 11.

21. The method of claim 20 where the pH is raised and maintained greater than 12.

22. The method of any of claims 15-20 where the gas stream containing CO₂ is diffused through a frit or stone to mix with the geological solution.

23. The method of any of claims 15-22, where the gas stream containing CO₂ is diffused in the geological solution at a high pressure.

24. The method of claim 23, where the gas stream containing CO₂ is diffused in the geological solution at a pressure greater than 40 psi.

25. The method of claim 24, where the gas stream containing CO₂ is diffused in the geological solution at a pressure greater than 100 psi.

26. The method of claim 25, where the gas stream containing CO₂ is diffused in the geological solution at a pressure greater than 200 psi.

27. The method of claim 26 where the gas stream containing CO₂ is diffused the geological solution at a pressure greater than 400 psi.

28. The method of any of claims 15-28, where the solids are removed and washed with water.

29. A method of removing carbon dioxide from a gas stream comprising the steps of
a. obtaining an aqueous geological solution containing one or more group 2 divalent cations
b. admixing with the aqueous geological solution from (a) a group 1 hydroxide solution between 5 and 15 weight % alkali hydroxide with a gas stream containing carbon dioxide;
c. admixing the solution from (b) with the aqueous geological solution (a) to achieve a pH greater than 9;
d. removing the solids that are formed from (c);
e. drying the solids;
f. grinding the solids;
g. admixing the solids with a siloxane resin to produce a reaction mixture;
h. forming the reaction mixture to produce a preform; and
i. heating the preform to cure the siloxane resin.
